(19) United States
(12) Patent Application Publication
(10) Pub. No.: US 2009/0070671 A1
(43) Pub. Date: Mar. 12, 2009

(54) COMMUNICATION METHOD, MOVING PICTURE REPRODUCTION DEVICE, AND INTERNET CONNECTION DEVICE

(75) Inventors: Satoshi Ogata, Chiba (JP); Tomoko Takahashi, Chiba (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/815,912

(22) PCT Filed: Feb. 3, 2006
(86) PCT No.: PCT/JP2006/301878

§ 371 Date: Aug. 9, 2007

(30) Foreign Application Priority Data
Feb. 10, 2005 (JP) 2005-035019
Jan. 17, 2006 (JP) 2006-009214

(51) Int. Cl. G06F 3/048; G06F 15/16; G06F 17/30

(52) U.S. Cl. 715/716; 709/227; 707/3; 707/E17.014

(57) ABSTRACT

There is provided a communication method capable of performing connection to the Internet by using another device having the Internet connection function even if a moving picture reproduction device does not have the Internet connection function. In this method, the moving picture reproduction device (101) creates an Internet connection signal (108) including URL information (106) and the like from Internet connection request information (111) and an URL table (107) recorded on a recording medium (105) and transmits it to the Internet connection device (103). The Internet connection device (103) receives the Internet connection signal (108), transmits the Internet connection request information (111) and the URL information (106) to a server (115), acquires and displays the Web site information (116) corresponding to the URL information (106).

### TECHNICAL FIELD

The present invention relates to a communication method for which an apparatus capable of playing back multimedia data such as video information and audio information including DVD and semiconductor memories (hereinafter referred to as a “moving picture playback apparatus”) connects to an Internet connecting apparatus capable of independently connecting to the Internet, and connects to and disconnects from the Internet even when the moving picture playback apparatus does not have a function of independently connecting to the Internet, and the moving picture playback apparatus and the Internet connecting apparatus.

### BACKGROUND ART

In recent years, with the spread of the Internet at homes, not only conventional Internet connection from personal computers but also independent Internet connection from various apparatuses such as mobile telephones and game machines, have started to be performed. Accordingly, Internet utilization methods in a variety of modes are developed.

Such Internet utilization methods include a utilization method in which a moving picture playback apparatus is connected to the Internet, which is disclosed in Patent Document 1, for example.

Patent Document 1: Japanese Patent Application Laid-Open No. 2004-088740 (see paragraph 0118, and the like)

### DISCLOSURE OF INVENTION

### Problems to be Solved by the Invention

A conventional technique disclosed in Patent Document 1, however, is a technique used for the case where a moving picture playback apparatus has a communication processing section for Internet connection and is directly connected to the Internet through the communication processing section. Thus, when various apparatuses are connected to each other and used as one system, Internet connection functions provided to the apparatuses overlap, and a problem arises that the cost for providing the connection functions is wasted.

In addition, there is also a problem that a viewer of the moving picture playback apparatus must provide wiring for various apparatuses for Internet connection and prepare devices such as cables and routers required for the connection, which are cumbersome and costly.

It is therefore an object of the present invention to provide a communication method for which, even when a moving picture playback apparatus such as a DVD player does not have an Internet connection function, by using another apparatus having an Internet connection function, the moving picture playback apparatus can connect to the Internet, and the moving picture playback apparatus and an Internet connecting apparatus.

### Means for Solving the Problem

A communication method of the present invention is for a moving picture playback apparatus capable of playing back multimedia data and not having a communication processing section for Internet connection. The communication method includes: connecting the moving picture playback apparatus to an Internet connecting apparatus having a communication processing section for Internet connection; and transmitting an Internet connection signal which is a signal for establishing an Internet connection by the Internet connecting apparatus, to the Internet connecting apparatus from the moving picture playback apparatus, and thereby the moving picture playback apparatus connects to the Internet through the Internet connecting apparatus.

A moving picture playback apparatus of the present invention is capable of playing back multimedia data and does not have a communication processing section for Internet connection. The apparatus includes: a generating section that generates an Internet connection signal which is a signal for establishing an Internet connection by an Internet connecting apparatus having an Internet connection function; a transmitting section that transmits the Internet connection signal generated by the generating section; and a receiving section that receives URL information as a result of the Internet connection through the Internet connecting apparatus based on the Internet connection signal transmitted by the transmitting section.

An Internet connecting apparatus of the present invention is capable of playing back multimedia data, connected to a moving picture playback apparatus not having a communication processing section for Internet connection, and transmits and receives an Internet connection signal and an Internet disconnection signal. The Internet connecting apparatus includes: a receiving section that receives the Internet connection signal transmitted from the moving picture playback apparatus upon Internet connection and receives the Internet disconnection signal transmitted from a server upon Internet disconnection; a storing section that stores medium playback position information and medium playback state information which are included in the Internet connection signal received by the receiving section, the medium playback position information being information of a playback position of the multimedia data being played back, and the medium playback state information being information of a playback state of the multimedia data being played back; a generating section that generates Internet connection request information which is information for requesting the server for Internet connection when the receiving section receives the Internet connection signal; and a transmitting section that transmits, upon Internet connection, the Internet connection request information generated by the generating section and transmits, upon Internet disconnection, to the moving picture playback apparatus the medium playback position information and the medium playback state information which are stored in the storing section.

### ADVANTAGEOUS EFFECT OF THE INVENTION

According to the present invention, even when a moving picture playback apparatus does not have an Internet function, by using an Internet function of an Internet connecting apparatus connected to the moving picture playback apparatus, the moving picture playback apparatus can connect to the Internet without increasing the numbers of routers and cables.

### BRIEF DESCRIPTION OF DRAWINGS

FIG. 1 is an overall configuration diagram for the case where a moving picture playback apparatus and an Internet connecting apparatus according to Embodiment 1 of the present invention are connected to each other for Internet connection;

FIG. 2 shows the configuration and connection state of the moving picture playback apparatus and the Internet connecting apparatus according to Embodiment 1 of the present invention;

FIG. 3 shows an Internet connection signal according to Embodiment 1 of the present invention;

FIG. 4 shows steps of transmitting and receiving signals and data that are necessary when the moving picture playback apparatus according to Embodiment 1 of the present invention connects to the Internet;

FIG. 5 is an overall configuration diagram for the case where the moving picture playback apparatus and the Internet connecting apparatus according to Embodiment 1 of the present invention are connected to each other for Internet connection;

FIG. 6 shows an Internet search signal according to Embodiment 1 of the present invention;

FIG. 7 shows steps of transmitting and receiving signals and data that are necessary when the moving picture playback apparatus according to Embodiment 1 of the present invention connects to the Internet;

FIG. 8 is an overall configuration diagram showing the flow of a signal and data when the moving picture playback apparatus according to Embodiment 1 of the present invention disconnects from the Internet;

FIG. 9 shows an Internet disconnection signal according to Embodiment 1 of the present invention;

FIG. 10 shows steps of transmitting and receiving data necessary when the moving picture playback apparatus according to Embodiment 1 of the present invention disconnects from the Internet; and

FIG. 11 shows a display method for an object having URL information which is displayed on a screen of an Internet connecting apparatus according to Embodiment 2 of the present invention.

### BEST MODE FOR CARRYING OUT THE INVENTION

Embodiments of the present invention will be described in detail below with reference to the drawings.

### Embodiment 1

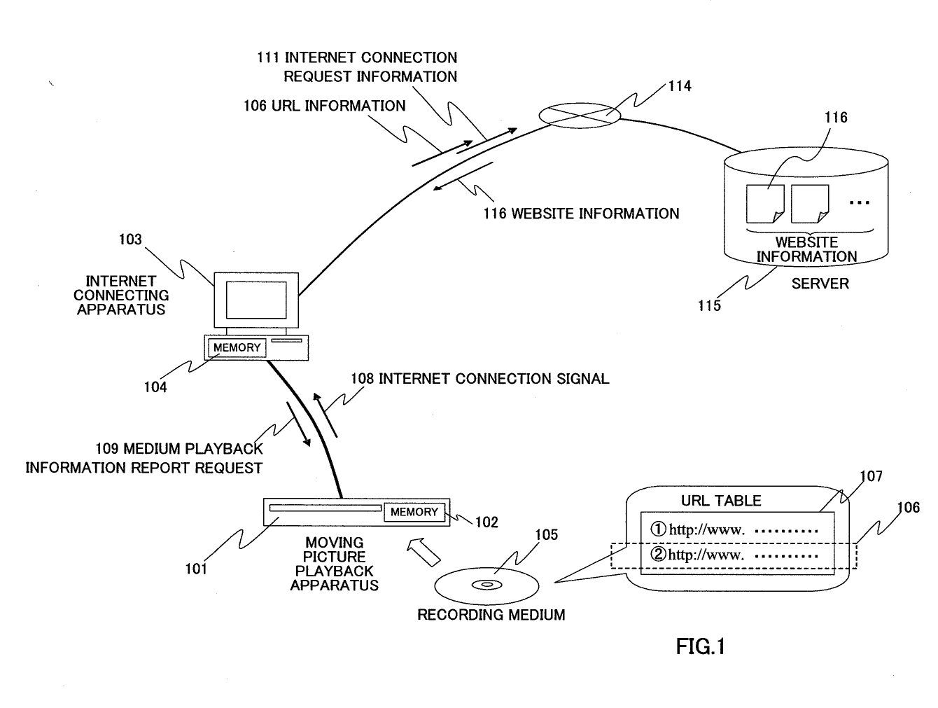

FIG. 1 is an overall configuration diagram showing the case where moving picture playback apparatus 101 and Internet connecting apparatus 103 according to Embodiment 1 of the present invention are connected to each other for Internet connection.

In FIG. 1, the apparatus having an Internet connection function (hereinafter, abbreviated as the “Internet connecting apparatus”) 103 is connected to moving picture playback apparatus 101 that does not have a communication processing section for Internet connection, and is also connected to server 115 through Internet network 114. Internet connecting apparatus 103 has memory 104.

Moving picture playback apparatus 101 has memory 102 and plays back information of recording medium 105 such as a DVD.

In recording medium 105, multimedia data such as video information and audio information to be played back by moving picture playback apparatus 101 is recorded. In the multimedia data, one or a plurality of URL information 106 is associated in an object unit or scene unit of video information. Namely, a link is provided so that it is possible to access a site on the Internet indicated by URL information 106 by clicking. URL information 106 is stored in URL table 107, for example, which is one table in recording medium 105.

Here, recording medium 105 is defined as a storage medium such as a DVD disc or a semiconductor memory such as a flash memory, in which video information and audio information are recorded. The video information and audio information as used herein are collectively defined as multimedia data.

When recording medium 105 is placed into moving picture playback apparatus 101 and played back, URL information 106 stored in URL table 107 in recording medium 105 is stored in memory 102 provided to moving picture playback apparatus 101.

Internet connecting apparatus 103 is connected to server 115 through Internet network 114. Server 115 has website information 116.

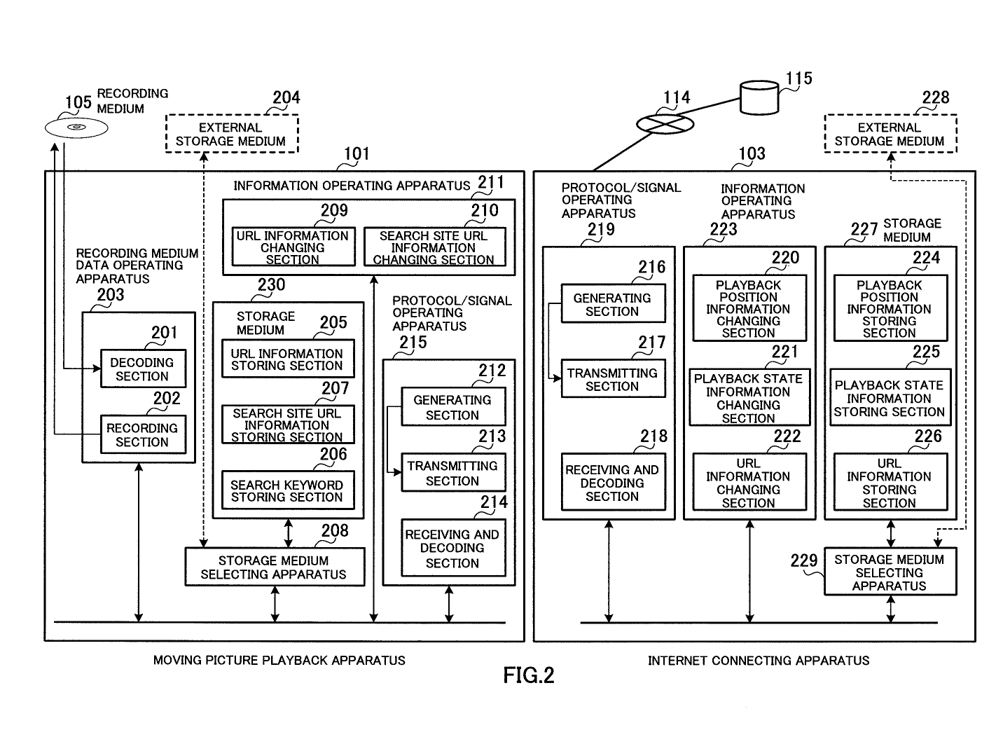

FIG. 2 shows the configuration and connection state of moving picture playback apparatus 101 and Internet connecting apparatus 103 according to Embodiment 1 of the present invention.

In FIG. 2, moving picture playback apparatus 101 plays back information of recording medium 105 such as a DVD, records information of recording medium 105, or deletes information of recording medium 105. Moving picture playback apparatus 101 includes protocol/signal operating apparatus 215, storage medium 230, storage medium selecting apparatus 208 and information operating apparatus 211.

Although in FIG. 2, storage medium 230 is shown as one built in moving picture playback apparatus 101, but external storage medium 204 which can be externally provided to moving picture playback apparatus 101 may be used instead of storage medium 230.

Protocol/signal operating apparatus 215 includes: generating section 212 for generating a protocol and a signal such as Internet connection signal 108; transmitting section 213 for transmitting the protocol and signal generated by generating section 212 to Internet connecting apparatus 103 connected to moving picture playback apparatus 101; and receiving and decoding section 214 (receiving section) for receiving and decoding the protocol and the signal transmitted to moving picture playback apparatus 101 from Internet connecting apparatus 103 connected to moving picture playback apparatus 101.

Storage medium 230 includes: URL information storing section 205 for recording URL information read from recording medium 105; search keyword storing section 206 for recording search keywords read from recording medium 105; and search site URL information storing section 207 for recording search site URL information to be used as a means of performing an Internet search using the search keywords read from recording medium 105. Storage medium 230 is the same as memory 102 in FIG. 1.

Storage medium selecting apparatus 208 is an apparatus for selecting which one of storage medium 230 and external storage medium 204 which are provided to moving picture playback apparatus 101, to be used as a recording medium for recording URL information, search keywords and search site URL information which are read from recording medium 105.

Information operating apparatus 211 includes: URL information changing section 209 for rewriting URL information recorded in URL information storing section 205; and search site URL information changing section 210 for rewriting search site URL information recorded in search site URL information storing section 207.

Internet connecting apparatus 103 is connected to moving picture playback apparatus 101 that does not have a communication processing section for Internet connection, and is also connected to server 115 through Internet network 114.

Internet connecting apparatus 103 includes protocol/signal operating apparatus 219, information operating apparatus 223, storage medium 227 and storage medium selecting apparatus 229.

Although in FIG. 2, storage medium 227 is shown as one built in Internet connecting apparatus 103, by using external storage medium 228 which can be externally provided to Internet connecting apparatus 103 instead of storage medium 227, the same operation can be also performed.

Protocol/signal operating apparatus 219 includes: generating section 216 for generating a protocol and a signal; transmitting section 217 for transmitting the protocol and signal generated by generating section 216 to moving picture playback apparatus 101; and receiving and decoding section 218 (receiving section) for receiving and decoding the protocol and the signal transmitted from moving picture playback apparatus 101 to Internet connecting apparatus 103 connected to moving picture playback apparatus 101.

Storage medium 227 includes: playback position information storing section 224 that records a playback position of recording medium 105, which is included in a protocol and a signal transmitted to Internet connecting apparatus 103 from moving picture playback apparatus 101 connected to Internet connecting apparatus 103; playback state information storing section 225 that records a playback state of recording medium 105, which is included in the protocol and the signal transmitted to Internet connecting apparatus 103 from moving picture playback apparatus 101 connected to Internet connecting apparatus 103; and URL information storing section 226 for recording URL information read from recording medium 105. Storage medium 227 is the same as memory 104 in FIG. 1.

Storage medium selecting apparatus 229 is an apparatus for selecting which one of storage medium 227 and external storage medium 228 which are provided to Internet connecting apparatus 103, to be used as a recording medium for recording playback position information, playback state information and URL information which are included in the protocol and the signal transmitted to Internet connecting apparatus 103 from moving picture playback apparatus 101 connected to Internet connecting apparatus 103.

Information operating apparatus 223 which is a changing means includes: playback position information changing section 220 for rewriting playback position information recorded in playback position information storing section 224; playback state information changing section 221 for rewriting playback state information recorded in playback state information storing section 225; and URL information changing section 222 for rewriting URL information recorded in URL information storing section 226.

In the present invention, moving picture playback apparatus 101 is connected to Internet connecting apparatus 103 by wire or wirelessly. By transmitting and receiving between moving picture playback apparatus 101 and Internet connecting apparatus 103 an Internet connection signal for Internet connection, an Internet search signal for Internet search and an Internet disconnection signal for Internet disconnection, which are generated by generating section 212 of moving picture playback apparatus 101 and generating section 216 of Internet connecting apparatus 103, moving picture playback apparatus 101 can connect to the Internet through Internet connecting apparatus 103.

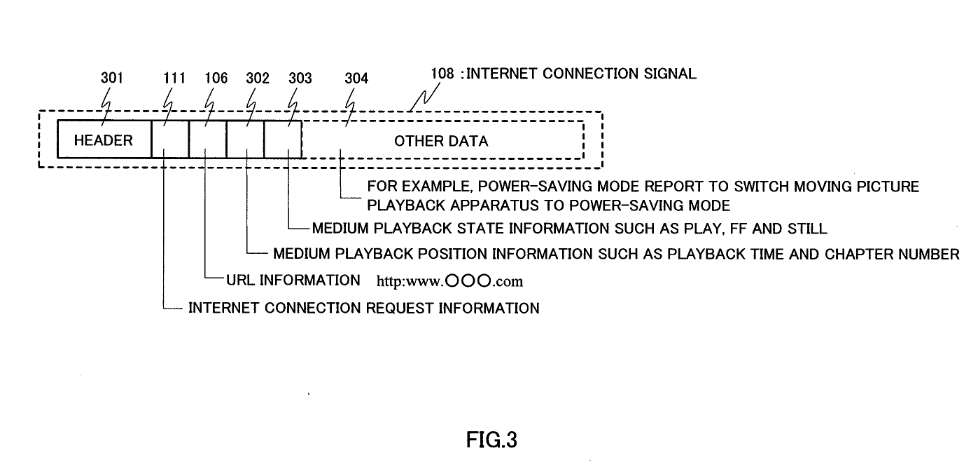

FIG. 3 shows Internet connection signal 108 to be transmitted to Internet connecting apparatus 103 from moving picture playback apparatus 101 when moving picture playback apparatus 101 connects to Internet network 114 through Internet connecting apparatus 103 in Embodiment 1.

Internet connection signal 108 is Internet communication data having an Internet connection protocol including after header 301, all or part of data including Internet connection request information 111 for establishing an Internet connection by Internet connecting apparatus 103 connected to moving picture playback apparatus 101: URL information 106 such as “http:www.∘∘∘.com” recorded in recording medium 105; medium playback position information 302 indicating a medium playback position, such as a playback time or chapter number, of recording medium 105 such as a DVD, upon transmission of Internet connection signal 108; medium playback state information 303 indicating a medium playback state, such as PLAY (playback), FF (fast forward), or STILL (stop), of recording medium 105 such as a DVD, upon transmission of Internet connection signal 108; and other data 304 such as power-saving mode report for switching moving picture playback apparatus 101 to a power-saving mode.

Other data 304 includes, for example, a signal for switching to a power-saving mode to be transmitted to moving picture playback apparatus 101 from Internet connecting apparatus 103 when moving picture playback apparatus 101 connects to the Internet. By this means, at the same time as Internet connecting apparatus 103 connected to moving picture playback apparatus 101 connects to the Internet, moving picture playback apparatus 101 that does not need to operate is switched to a power-saving mode, so that it is possible to reduce power consumption. Other data 304 is not necessarily included.

Next, the operation performed when moving picture playback apparatus 101 connects to the Internet through Internet connecting apparatus 103 will be described with reference to the drawings.

When a viewer switches to an Internet connection during a playback of multimedia data such as video information and audio information by moving picture playback apparatus 101, the playback position and playback state of the multimedia data such as video information and audio information upon switching to the Internet are stored in some kind of apparatus or memory. By this means, when the playback of the multimedia data such as video information and audio information is returned from the Internet connection and the viewer views the multimedia data again, moving picture playback apparatus 101 can easily return to a state before the Internet connection, and therefore it is convenient.

Conventionally, by providing a non-volatile memory to moving picture playback apparatus 101 and recording a medium playback position and playback information in the non-volatile memory, moving picture playback apparatus 101 can return to a state before the Internet connection. On the other hand, in Embodiment 1, by transmitting Internet connection signal 108 including medium playback position information 302 and medium playback state information 303 to Internet connecting apparatus 103 from moving picture playback apparatus 101 and storing Internet connection signal 108 in memory 104 provided to Internet connecting apparatus 103, it is possible to hold the playback position and playback state of multimedia data such as video information and audio information without providing a non-volatile memory in moving picture playback apparatus 101.

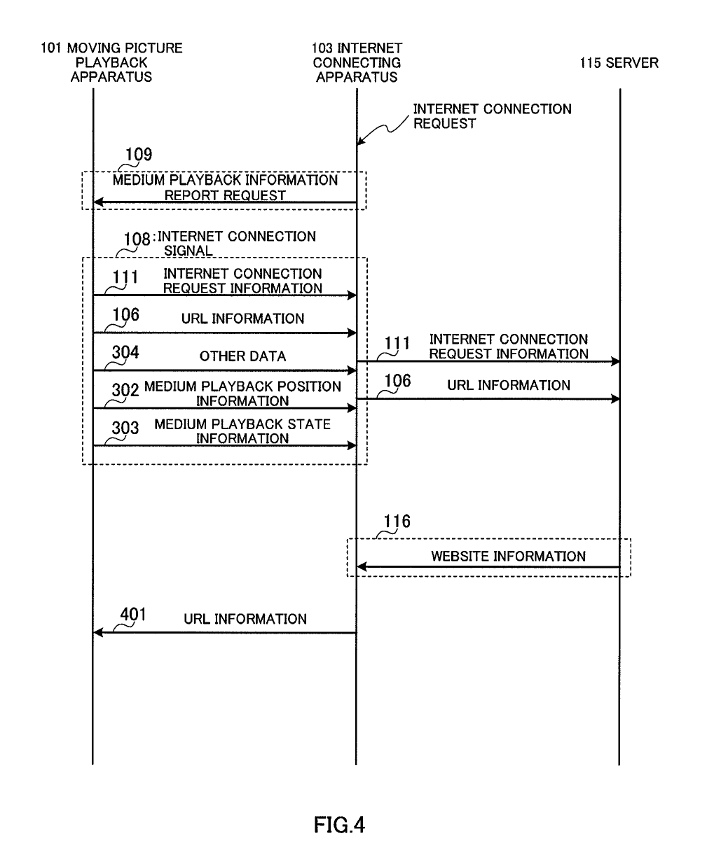

FIG. 4 shows steps of transmitting and receiving signals and data that are necessary when moving picture playback apparatus 101 connects to the Internet in Embodiment 1.

When the viewer places recording medium 105 into moving picture playback apparatus 101, moving picture playback apparatus 101 reads URL information, search site URL information and search keywords from recording medium 105 by decoding section 201 of recording medium data operating apparatus 203 and records the URL information, the search site URL information and the search keywords in URL information storing section 205, search site URL information storing section 207 and search keyword storing section 206, respectively.

The timing at which URL information, search site URL information and search keywords are recorded in URL information storing section 205, search site URL information storing section 207 and search keyword storing section 206, respectively, is not limited to when recording medium 105 is placed into moving picture playback apparatus 101. Such information can be recorded at the timing set by a user.

When the viewer switches to an Internet connection during the playback of multimedia data such as video information and audio information in moving picture playback apparatus 101, moving picture playback apparatus 101 obtains medium playback position information 302 and medium playback state information 303 of the multimedia data such as video information and audio information upon switching to the Internet. Furthermore, moving picture playback apparatus 101 obtains from memory 102 provided to moving picture playback apparatus 101 URL information 106 associated with an object or scene selected by the viewer from URL table 107 recorded in recording medium 105, and adds header 301 and Internet connection request information 111 serving as a cue to connect to the Internet, to medium playback position information 302, medium playback state information 303 and URL information 106 and thereby generates Internet connection signal 108 such as the one shown in FIG. 3.

Then, while the viewer is viewing, in moving picture playback apparatus 101, multimedia data such as video information and audio information stored in recording medium 105, for example, an item that the viewer wants or a character who the viewer is interested in (hereinafter, referred to as an “object” as an element composing multimedia data such as video information and audio information) is displayed, and the viewer tries to obtain information of the object.

If the object has URL information 106, the viewer selects the object on a screen of moving picture playback apparatus 101 and presses a remote control key (not shown) or a main body key (not shown) and thereby transmits an Internet connection request to Internet connecting apparatus 103.

Internet connecting apparatus 103 receives the Internet connection request from the viewer and issues medium playback information report request 109 to moving picture playback apparatus 101.

Here, the viewer is reported that moving picture playback apparatus 101 is in transition of connecting to Internet network 114 through Internet connecting apparatus 103, by a method in which a message such as “connecting” is displayed on a screen of Internet connecting apparatus 103 or moving picture playback apparatus 101, a method in which the color of the object having URL information 106 to be displayed on a screen of Internet connecting apparatus 103 or moving picture playback apparatus 101 is changed, or a method in which the color of button displayed on a screen of Internet connecting apparatus 103 or moving picture playback apparatus 101 is changed.

When moving picture playback apparatus 101 receives medium playback information report request 109 from Internet connecting apparatus 103, moving picture playback apparatus 101 obtains URL information 106 associated with the object from memory 102 provided to moving picture playback apparatus 101. Moving picture playback apparatus 101 then transmits to Internet connecting apparatus 103 connected to moving picture playback apparatus 101 Internet connection signal 108 having an Internet connection protocol shown in FIG. 3, which includes obtained URL information 106, medium playback position information 302, medium playback state information 303, Internet connection request information 111 for reporting the Internet connection and other data 304.

When Internet connecting apparatus 103 receives Internet connection signal 108 from moving picture playback apparatus 101, Internet connecting apparatus 103 stores received medium playback position information 302 and medium playback state information 303 in memory 104 provided to Internet connecting apparatus 103 and transmits Internet connection request information 111 and URL information 106 to server 115 through Internet network 114.

Server 115 receives Internet connection request information 111 and URL information 106 from Internet connecting apparatus 103 through Internet network 114, obtains website information 116 corresponding to URL information 106 and transmits website information 116.

Internet connecting apparatus 103 obtains website information 116 stored in server 115 via Internet network 114 based on URL information 106 associated with the object and displays website information 116.

Internet connecting apparatus 103 having received website information 116 transmits to moving picture playback apparatus 101 URL information 401 which is URL information of received website information 116. When moving picture playback apparatus 101 receives URL information 401, moving picture playback apparatus 101 checks whether received URL information 401 matches URL information 106 in recording medium 105.

If URL information 401 matches URL information 106, moving picture playback apparatus 101 does not perform any processing. On the other hand, if URL information 401 does not match URL information 106 and the connection is successful, moving picture playback apparatus 101 regards website information 116 as being not changed but URL information 106 as being changed, and thus, overwrites URL information 106 recorded in recording medium 105 or in storage medium 230 with obtained URL information 401. By this processing, URL information in recording medium 105 or in storage medium 230 is always the latest, and therefore, when the viewer obtains information of the same object next time, it becomes an effective means.

When a plurality of objects each have URL information, and Internet connecting apparatus 103 obtains the URL information for the objects, Internet connecting apparatus 103 displays a plurality of website information 116 based on the plurality of URL information, resulting in a complicated screen which may be very annoying. Therefore, the viewer is reported that moving picture playback apparatus 101 has succeeded in connecting to Internet network 114 through Internet connecting apparatus 103, by a method in which a message such as “connection success” indicating that an Internet connection is successful is displayed on a screen of Internet connecting apparatus 103 or moving picture playback apparatus 101, a method in which the color of an object having URL information 106 to be displayed on a screen of Internet connecting apparatus 103 or moving picture playback apparatus 101 is changed, or a method in which the color of button displayed on a screen of Internet connecting apparatus 103 or moving picture playback apparatus 101 is changed.

By this means, Internet connecting apparatus 103 obtains website information 116 stored in server 115 via Internet network 114 based on URL information associated with the object and displays website information 116.

In this way, the viewer can freely connect to Internet network 114 through Internet connecting apparatus 103 during the playback of recording medium 105 by moving picture playback apparatus 101 and view website information 116 associated with the object.

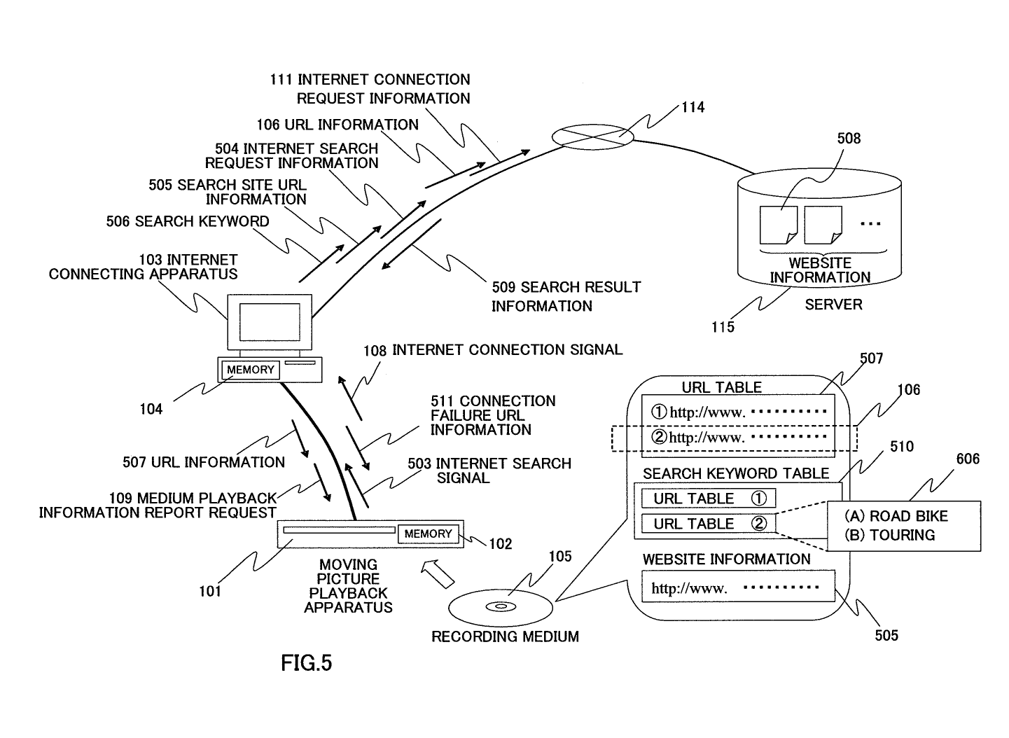

Now, the operation performed when website information corresponding to URL information 106 recorded in recording medium 105 is not present in server 115 will be described using FIG. 5. FIG. 5 is an overall configuration diagram showing the flow of signals and data for the case where, when moving picture playback apparatus 101 connects to Internet network 114 through Internet connecting apparatus 103 but cannot find website information corresponding to URL information 106 recorded in recording medium 105 in Embodiment 1, a website including content similar to the website information corresponding to URL information 106 is searched. In addition, in FIG. 5, parts that are the same as those in FIG. 1 will be assigned the same reference numerals without further explanations.

In FIGS. 2, 3 and 4, the case has been described where the viewer can view, during the playback of recording medium 105 by moving picture playback apparatus 101, website information 116 based on URL information 106 recorded in recording medium 105. However, website information 116 based on URL information 106 is not always present on server 115, and website information 116 may not be accessible for some reason such as website information 116 being deleted by a creator.

In this case, there is a problem that an advantage of the present invention that the viewer can obtain on the Internet information of the object or the like recorded in the multimedia data while viewing multimedia data, is permanently lost. Accordingly, in this case, the problem is avoided by searching for alternative website information by a search site using search keywords recorded in recording medium 105.

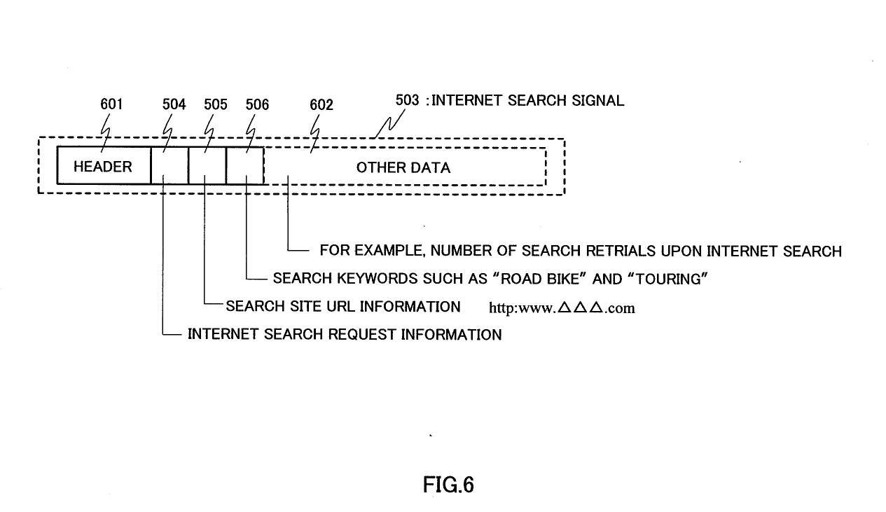

FIG. 6 shows Internet search signal 503 to be transmitted to Internet connecting apparatus 103 from moving picture playback apparatus 101.

Internet search signal 503 is a signal having an Internet search protocol including, after header 601, all or part of data including Internet search request information 504 for performing a search on Internet network 114 by Internet connecting apparatus 103 connected to moving picture playback apparatus 101; URL information (hereinafter, referred to as “search site URL information”) 505 such as “http:www.ΔΔΔ.com” representing a search site recorded in recording medium 105; search keywords 506 recorded in recording medium 105; and other data 602 such as the number of search retrials upon Internet search.

Search site URL information 505 is not limited to one recorded in recording medium 105 and search site URL information can be recorded in advance in external storage medium 204 by a user and used. Alternatively, one or a plurality of search site URL information may be pre-installed on moving picture playback apparatus 101, and the user may use one of the search site URL information that he/she likes, as search site URL information.

Other data 602 includes, for example, the number of retrials for Internet search when moving picture playback apparatus 101 performs an Internet search through Internet connecting apparatus 103. By this means, when a timeout occurs in the Internet search, time-consuming processing can be forcefully terminated in a short period of time. Other data 602 is not necessarily included.

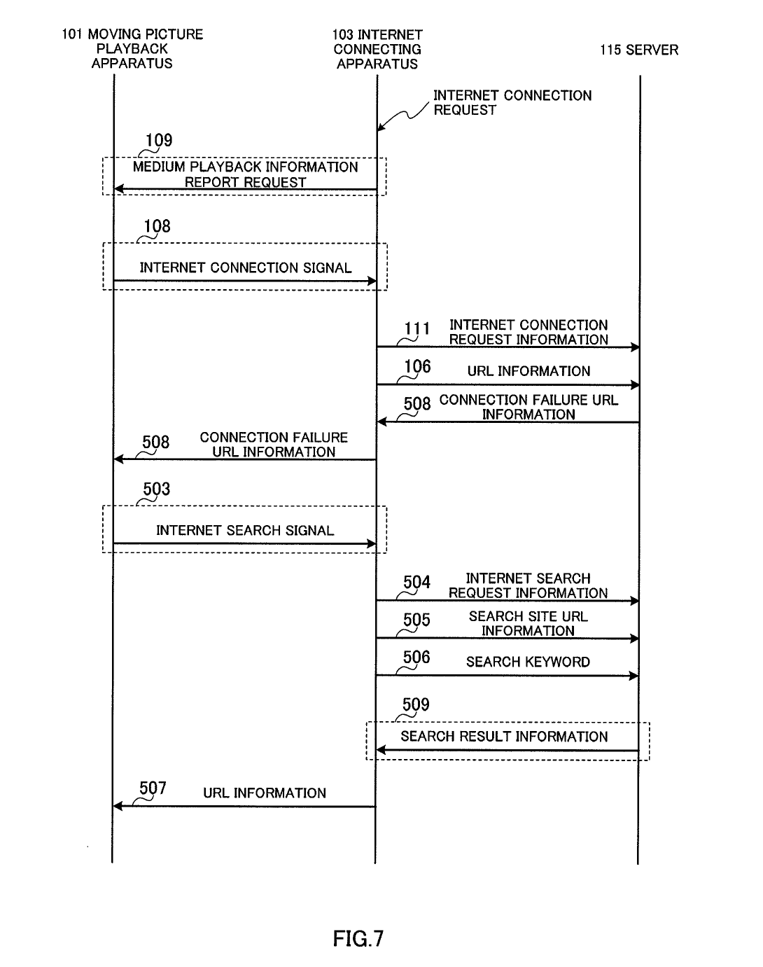

FIG. 7 shows steps of transmitting and receiving signals and data that are necessary when moving picture playback apparatus 101 connects to the Internet through Internet connecting apparatus 103 but a site corresponding to the URL information recorded in moving picture playback apparatus 101 cannot be found in Embodiment 1.

The flow of signals and operation upon the Internet search will be described using FIGS. 5, 6 and 7.

While the viewer is viewing, through moving picture playback apparatus 101, multimedia data such as video information and audio information stored in recording medium 105, an object, for example, is displayed, and the viewer tries to obtain information of the object.

When the viewer transmits an Internet connection request to Internet connecting apparatus 103, Internet connecting apparatus 103 performs the above-described Internet connection steps and transmits Internet connection request information 111 and URL information 106 to server 115 through Internet network 114.

Server 115 receives Internet connection request information 111 and URL information 106 from Internet connecting apparatus 103 through Internet network 114 and tries to obtain website information corresponding to URL information 106; however, if server 115 cannot obtain the website information due to the website information being deleted or the like, server 115 transmits to Internet connecting apparatus 103 URL information (hereinafter, referred to as “connection failure URL information”) 511 indicating an error.

When Internet connecting apparatus 103 transmits connection failure URL information 511 to moving picture playback apparatus 101, moving picture playback apparatus 101 having received connection failure URL information 511 determines that the connection has failed. Moving picture playback apparatus 101 then obtains from storage medium 230 search site URL information 505 and search keywords 506 in search keyword table 510. Moving picture playback apparatus 101 transmits to Internet connecting apparatus 103 Internet search signal 503 having an Internet search protocol including search keywords 506, search site URL information 505, Internet search request information 504, and the like, and starts Internet search processing. Internet search signal 503 is generated by generating section 203 of moving picture playback apparatus 101.

At this time, the viewer is reported that moving picture playback apparatus 101 has failed to connect to Internet network 114 through Internet connecting apparatus 103 or moving picture playback apparatus 101 is in the process of reconnecting, by a method in which a message such as “connection failed” or “reconnecting” is displayed on a screen of Internet connecting apparatus 103 or moving picture playback apparatus 101, a method in which the color of an object having URL information 106 to be displayed on a screen of Internet connecting apparatus 103 or moving picture playback apparatus 101 is changed, or a method in which the color of the button displayed on a screen of Internet connecting apparatus 103 or moving picture playback apparatus 101 is changed. Internet connecting apparatus 103 which receives Internet search signal 503 transmits Internet search request information 504, search site URL information 505 and search keywords 506 to Internet network 114. Server 115 then searches for a search engine based on search site URL information 505 received through Internet network 114 and obtains search result information 509 indicating results of the search performed by the searched search engine using search keywords 506.

In search result information 509, at least one website information 508 containing search keywords 506 is arranged.

When Internet connecting apparatus 103 receives search result information 509 transmitted from server 115, the viewer can select website information 508 that he/she wants to view from the search results indicated by search result information 509 and can view website information 508.

In this way, even when website information based on URL information 106 recorded in recording medium 105 cannot be searched due to the website information being deleted or the like, the viewer can freely connect to Internet network 114 through Internet connecting apparatus 103 during the playback of recording medium 105 by moving picture playback apparatus 101 and can view website information 508 associated with the object.

Also, Internet connecting apparatus 103 stores in storage medium 227 search result information 509 or website information 508 selected by the viewer from search results indicated by search result information 509 and transmits URL information 507 for website information 508 to moving picture playback apparatus 101 connected to Internet connecting apparatus 103.

When URL information 507 transmitted to moving picture playback apparatus 101 from Internet connecting apparatus 103 is different from URL information 106 recorded in recording medium 105 and is not URL information indicating an error, if recording medium 105 is rewritable, moving picture playback apparatus 101 rewrites URL information 106 in recording medium 105 with URL information 507 transmitted from Internet connecting apparatus 103. On the other hand, if recording medium 105 is not rewritable, moving picture playback apparatus 101 writes URL information 507 transmitted from Internet connecting apparatus 103 into rewritable storage medium 230 placed on moving picture playback apparatus 101.

A storage medium into which URL information 507 is written can also be selected by the user. By this means, it is possible to avoid a problem that when information of an object recorded in a recording medium is obtained again, the information cannot be obtained because a connection destination cannot be found.

In this way, when moving picture playback apparatus 101 connects to the Internet through Internet connecting apparatus 103 and tries to obtain website information based on URL information 106 recorded in recording medium 105 but cannot find the website information, an alternative website is searched by a search site using search keywords 506, and URL information 507 for a website corresponding to alternative website information 508 is recorded in recording medium 105, storage medium 230 provided to moving picture playback apparatus 101 or storage medium 227 provided to Internet connecting apparatus 103.

In addition, when storage medium 230 which is provided to moving picture playback apparatus 101 and records URL information is removable, the recorded URL information can be viewed with another device such as a personal computer, and therefore it is convenient.

Now, the case will be described where an Internet connection is disconnected by Internet connecting apparatus 103.

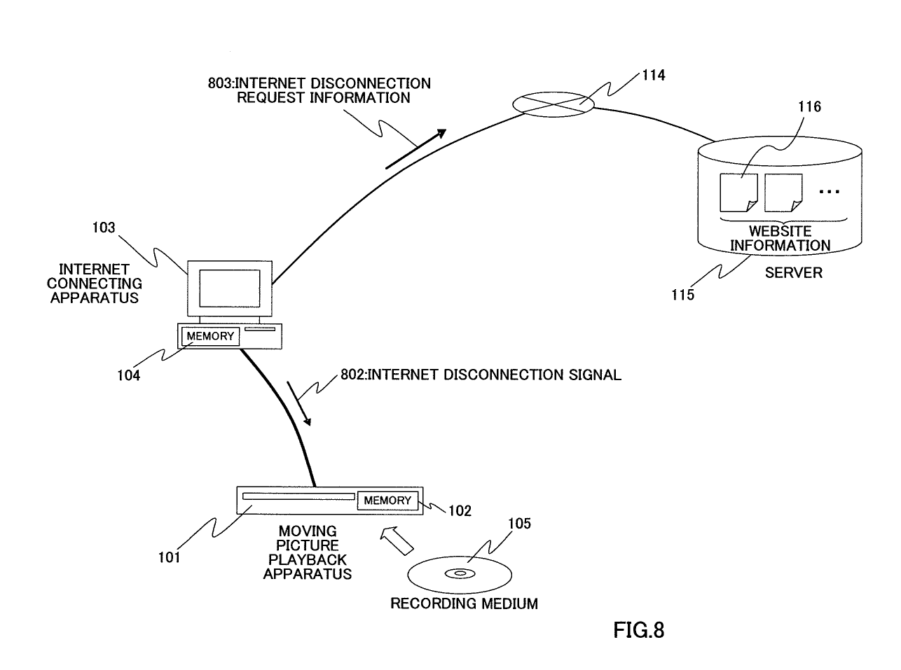

FIG. 8 is an overall configuration diagram showing the flow of a signal and data when moving picture playback apparatus 101 in Embodiment 1 disconnects from the Internet.

After finishing viewing website information 116, when the viewer presses a remote control key (not shown) or the like as a cue to disconnect an Internet connection, an Internet disconnection request is issued to Internet connecting apparatus 103.

When Internet connecting apparatus 103 connected to moving picture playback apparatus 101 receives the Internet disconnection request from the viewer or the like, Internet connecting apparatus 103 transmits Internet disconnection request information 803 to server 115 and reads from memory 104 provided to Internet connecting apparatus 103 medium playback position information 302 and medium playback state information 303 which are obtained from moving picture playback apparatus 101 upon Internet connection.

Internet connecting apparatus 103 transmits to moving picture playback apparatus 101 Internet disconnection signal 802 which is Internet communication data having an Internet disconnection protocol including medium playback position information 302 and medium playback state information 303 which respectively indicate a medium playback position and a medium playback state for the case where moving picture playback apparatus 101 returns from the Internet, Internet disconnection report signal 902 which will be described later, and transmits Internet disconnection request information 803 to server 115. Thus, the Internet connection is disconnected.

By this means, multimedia data such as video information and audio information that is played back by moving picture playback apparatus 101 can be switched to a state immediately before the viewer connects to the Internet or to a mode in which the multimedia data returns to a viewer's arbitrary state.

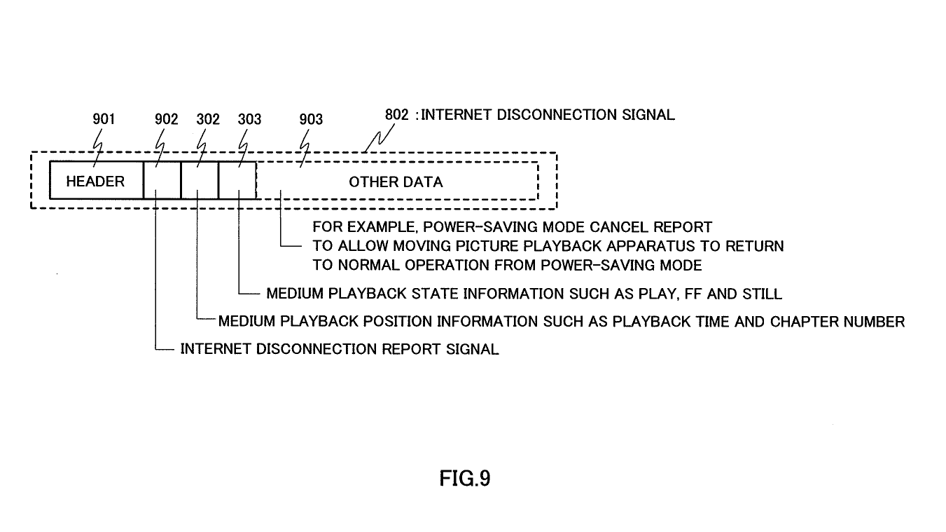

FIG. 9 shows Internet disconnection signal 802 to be transmitted to moving picture playback apparatus 101 from Internet connecting apparatus 103 when an Internet connection by Internet connecting apparatus 103 in Embodiment 1 is disconnected and then moving picture playback apparatus 101 returns to playback multimedia data such as video information and audio information.

As shown in FIG. 9, Internet disconnection signal 802 is a signal having an Internet disconnection protocol including, starting with header 901, all or part of data including Internet disconnection report signal 902; medium playback position information 302 such as a playback time or chapter number of recording medium 105 such as a DVD, for when an Internet connection is established, which is read from memory 104; medium playback state information 303 such as PLAY (playback), FF (fast forward), or STILL (stop) for recording medium 105 such as a DVD, for when the Internet connection is established; and other data 903.

For other data 903, for example, when moving picture playback apparatus 101 disconnects from the Internet, by transmitting from Internet connecting apparatus 103 to moving picture playback apparatus 101 a power-saving mode cancel report for returning to a normal operation from a power-saving mode, that is, a signal for switching to a normal operation from a power-saving mode, moving picture playback apparatus 101 can return to the normal operation from the power-saving mode at the same time as Internet connecting apparatus 103 disconnects from the Internet. Although, as with Internet connection signal 108, Internet disconnection signal 802 includes other data 903 separately from medium playback position information 302 and medium playback state information 303, other data 903 is not necessarily included.

When disconnecting an Internet connection and returning, in order to return using a medium playback position and medium playback information that are different from those for the Internet connection, it is also possible to store a playback position and a playback state that the viewer desires in Internet disconnection signal 802 as medium playback position information 302 and medium playback state information 303 instead of storing medium playback position information 302 and medium playback state information 303 which are included in Internet disconnection signal 802, and transmit Internet disconnection signal 802 to Internet connecting apparatus 103 connected to moving picture playback apparatus 101. When Internet connecting apparatus 103 is in transition of connecting to the Internet or has succeeded in Internet connection or during viewing of the Internet or after viewing of the Internet, it is also possible to maintain the above-described playback state or playback position of a medium played back by moving picture playback apparatus 101 for when the viewer starts to view the Internet or switch to the playback state or playback position which are different from the playback state or playback position for when the viewer starts to view the Internet.

By doing so, when an Internet connection is disconnected, a screen display of Internet connecting apparatus 103 connected to moving picture playback apparatus 101 can return to the playback of multimedia data such as video information and audio information using a playback position and a playback state that are different from those interrupted upon Internet connection, for example, using a playback position and a playback state according to a viewer's preference.

Next, the operation will be described.

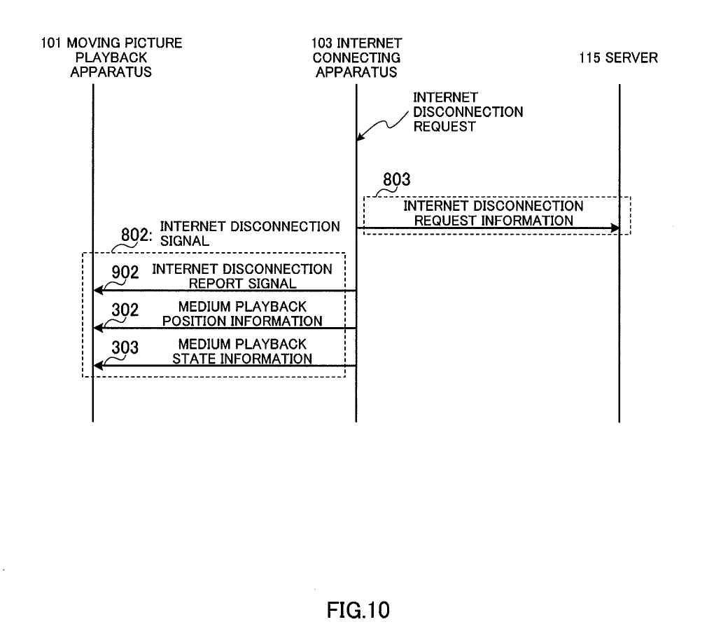

FIG. 10 shows steps of transmitting and receiving data necessary when moving picture playback apparatus 101 in Embodiment 1 disconnects from the Internet.

When disconnecting an Internet connection and returning to the playback of multimedia data such as video information and audio information, Internet connecting apparatus 103 reads medium playback position information 302 and medium playback state information 303 for the multimedia data which are acquired upon Internet connection, from memory 104 provided to Internet connecting apparatus 103, generates Internet disconnection signal 802 according to an Internet disconnection protocol, and transmits Internet disconnection signal 802 to moving picture playback apparatus 101.

Moving picture playback apparatus 101 receives Internet disconnection signal 802 from Internet connecting apparatus 103, extracts Internet disconnection report signal 902 from Internet disconnection signal 802, and determines the disconnection of the Internet connection by Internet connecting apparatus 103. Also, moving picture playback apparatus 101 extracts from Internet disconnection signal 802 medium playback position information 302 and medium playback state information 303 which respectively indicate a playback position and a playback state for when an Internet connection is established or a playback position and a playback state set by the viewer according to a viewer's preference, and plays back recording medium 105 such as a DVD using the playback position and playback state for when the Internet connection is established or the playback position and playback state set by the viewer according to the viewer's preference, based on medium playback position information 302 and medium playback state information 303. Internet connecting apparatus 103 transmits Internet disconnection request information 803 to server 115.

According to Embodiment 1, by using the Internet connection function of Internet connecting apparatus 103 connected to moving picture playback apparatus 101, it is possible to obtain an advantageous effect as if moving picture playback apparatus 101 has an Internet connection function, and prevent overlapping of the Internet connection functions provided to the apparatuses. In addition, according to Embodiment 1, it is possible to prevent overlapping of the Internet connection functions provided to the apparatuses, and therefore it is not necessary to prepare extra devices such as cables and routers, so that it is possible to reduce cost and trouble.

Particularly, when multimedia data such as video information and audio information played back by moving picture playback apparatus 101 has URL information 106, it is possible to make the viewer unaware of connection between moving picture playback apparatus 101 and Internet connecting apparatus 103 connected to moving picture playback apparatus 101 when using the Internet function.

### Embodiment 2

Now, Embodiment 2 of the present invention will be described.

Embodiment 2 shows a specific example of a display of an object having URL information 106 in Internet connecting apparatus 103, based on the above-described Embodiment 1.

Specifically, when, out of video information and audio information played back by moving picture playback apparatus 101, an object displayed on a screen of Internet connecting apparatus 103 connected to moving picture playback apparatus 101 has URL information 106, it is necessary to report to the viewer that the object has URL information 106.

A method will be described below for allowing the viewer to recognize that the object has URL information 106, when the object having URL information 106 is displayed.

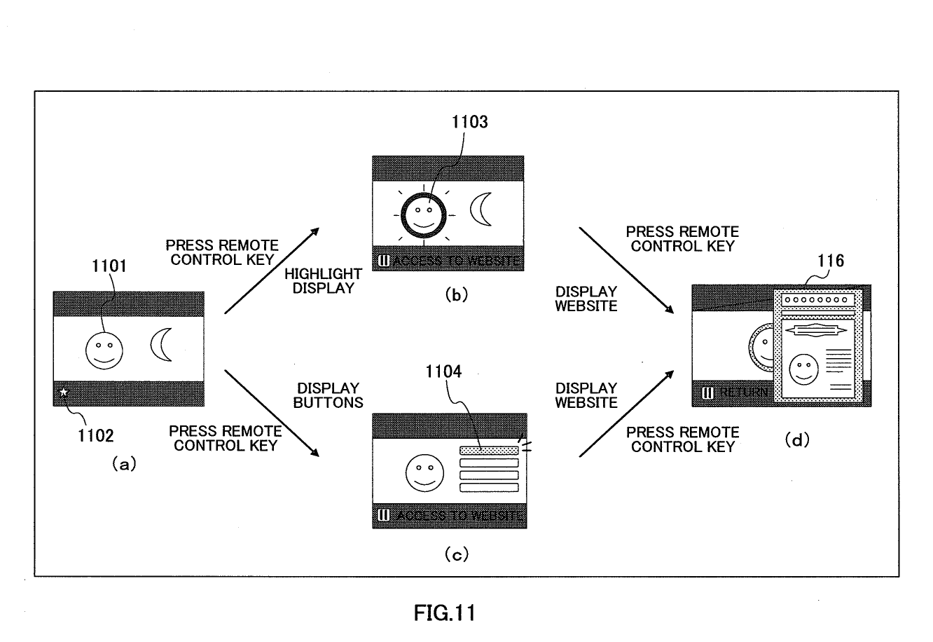

FIGS. 11(a) to (d) are diagrams each showing a specific example of a display method for an object having URL information 106 which is displayed on a screen of Internet connecting apparatus 103.

Specifically, FIG. 11(a) to (d) show the flow of screen displays before moving picture playback apparatus 101 connects to the Internet by a viewer's operation when, out of multimedia data such as video information and audio information recorded in recording medium 105 and played back by moving picture playback apparatus 101, an object having URL information 106 is displayed on a screen of Internet connecting apparatus 103.

FIG. 11(a) shows an example screen for the case where, when object 1101 displayed on a screen of Internet connecting apparatus 103 connected to moving picture playback apparatus 101 has URL information 106, by displaying mark 1102 on the screen, the viewer is reported that object 1101 has URL information 106.

In this case, mark 1102 does not have URL information 106 and is intended to only report to the viewer that object 1101 being displayed has URL information 106. Thus, mark 1102 is small in size and displayed in a corner of the screen. In this way, upon displaying mark 1102, it is preferable that mark 1102 does not hinder the viewing of video information and audio information by the viewer.

When mark 1102 is displayed and the viewer presses a remote control key (not shown), object 1101 having URL information 106 is highlight displayed.

At this time, it is also possible to transit video of moving picture playback apparatus 101 to a state for easy operation, such as PAUSE.

When the viewer views a website based on URL information 106, the viewer selects and determines highlight displayed object 1103 by pressing a remote control key (not shown).

Then, Internet connecting apparatus 103 connected to moving picture playback apparatus 101 accesses server 115 through Internet network 114 and obtains and displays website information 116 based on URL information 106 associated with object 1103.

Further, as shown in FIG. 11(b), when object 1101 having URL information 106 is displayed, it is of course possible to report to the viewer that object 1101 has URL information 106 by highlight displaying object 1101 without displaying mark 1102.

Alternatively, for another method for reporting to the viewer that object 1101 being displayed has URL information 106, it is of course possible to display button 1104 having URL information 106 on a screen as shown in FIG. 11(c), when mark 1102 is displayed and the viewer presses a remote control key as shown in FIG. 11(a).

Button 1104 having URL information 106 has the same URL information 106 as object 1101 being displayed. Unlike object 1101 arranged in disorder, one or all of URL information 106 out of object 1101 being displayed is arranged and displayed on the screen as button 1104. Thus, button 1104 has an advantage of allowing the viewer to perform visually easy operation when selecting URL information 106.

At this time, during viewing of the Internet, by performing a playback method in which the playback position of a medium played back by moving picture playback apparatus 101 is transited using a pattern different from that for when the viewer starts to view the Internet, video of moving picture playback apparatus 101 can be transited to a state for easy operation, such as PAUSE.

When the viewer views a website based on URL information 106, the viewer selects and determines button 1104 having URL information 106 by pressing a remote control key (not shown). As a result, as shown in FIG. 11(d), Internet connecting apparatus 103 connected to moving picture playback apparatus 101 accesses server 115 through Internet network 114 and obtains and displays website information 116 based on URL information 106 associated with button 1104.

It is also possible to use a method of reporting to the viewer that object 1101 has URL information 106, without displaying mark 1102 which reports to the viewer that object 1101 has URL information 106, but by displaying button 1104 when object 1101 having URL information 106 is displayed.

In this way, according to Embodiment 2, the viewer can easily view website information 116 based on URL information 106 associated with object 1101 without any difficult operation.

As described above, according to one embodiment of the present invention, in a communication method to be used by moving picture playback apparatus 101 capable of playing back a video/audio format having video information or audio information, by connecting moving picture playback apparatus 101 to Internet connecting apparatus 103, moving picture playback apparatus 101 can connect to the Internet, and, by transmitting and receiving Internet connection signal 108 and Internet disconnection signal 802 which have protocols capable of connecting to the Internet and returning from the Internet, it is possible to establish a pseudo-Internet connection from moving picture playback apparatus 101 having no Internet function.

According to one embodiment of the present invention, when a screen display of Internet connecting apparatus 103 connected to moving picture playback apparatus 101 is switched from a medium playback display provided by moving picture playback apparatus 101 to an Internet display provided by Internet connecting apparatus 103, or is switched from an Internet display provided by Internet connecting apparatus 103 to a medium playback display provided by moving picture playback apparatus 101, by providing the playback position and playback information for a medium being played back by moving picture playback apparatus 101 to Internet connecting apparatus 103 from moving picture playback apparatus 101 or to moving picture playback apparatus 101 from Internet connecting apparatus 103, even when the screen of Internet connecting apparatus 103 connected to moving picture playback apparatus 101 is switched to an Internet display while the viewer is viewing a moving picture and audio information being played back by moving picture playback apparatus 101, it is possible to return, regardless of the state of moving picture playback apparatus 101, to a playback state and a playback position of the moving picture and audio information played back by moving picture playback apparatus 101, for when the viewer switches to the Internet display.

According to one embodiment of the present invention, when the screen display of Internet connecting apparatus 103 connected to moving picture playback apparatus 101 is switched from a medium playback display provided by moving picture playback apparatus 101 to an Internet display provided by Internet connecting apparatus 103, by providing URL information 106 associated with an object displayed by a medium being played back by moving picture playback apparatus 101 to Internet connecting apparatus 103 from moving picture playback apparatus 101, if URL information 106 is recorded in a moving picture and audio information being played back by moving picture playback apparatus 101, without the viewer directly inputting a URL, Internet connecting apparatus 103 connected to moving picture playback apparatus 101 can display a website based on URL information 106.

According to one embodiment of the present invention, by adopting Internet connection signal 108 and Internet disconnection signal 802 which have protocols for implementing the above-described reporting method, when moving picture playback apparatus 101 connects to the Internet or returns from the Internet, necessary information can be efficiently transmitted and received.

According to one embodiment of the present invention, when website information based on URL information 106 associated with a moving picture and audio information being played back by moving picture playback apparatus 101 cannot be found on server 115 by the above-described reporting method, by providing search keywords 506 and search site URL information 505 which are recorded in recording medium 105 being played back by moving picture playback apparatus 101 to Internet connecting apparatus 103, even if the website information based on URL information 106 cannot be found, website information 508 including content similar to the website information based on URL information 106 can be searched.

According to one embodiment of the present invention, by adopting Internet search signal 503 having a protocol for implementing the above-described reporting method, when moving picture playback apparatus 101 performs an Internet search, necessary information can be efficiently searched.

According to one embodiment of the present invention, by providing to moving picture playback apparatus 101 an LSI so that part or all of the above-described communication method is implemented by hardware, it is possible to implement the present invention by hardware.

According to one embodiment of the present invention, by using a program (software) for implementing part or all of the above-described communication method, and a storage medium such as a memory recording such a program (software), and by providing the program (software) and the storage medium such as memory 102 to moving picture playback apparatus 101, it is possible to implement the present invention by a program (software).

According to one embodiment of the present invention, by recording part or all of the above-described program (software) in a storage medium such as an optical disc, a version upgrade or rewriting of the program (software) using the storage medium such as an optical disc is possible.

According to one embodiment of the present invention, when moving picture playback apparatus 101 extracts playback position information 302 and playback state information 303 for a medium and provides Internet connection signal 108 including URL information 106 to Internet connecting apparatus 103, a storage medium such as memory 104 of Internet connecting apparatus 103 stores medium playback position information 302 and medium playback state information 303, so that, even if moving picture playback apparatus 101 does not have a non-volatile memory, when Internet connection signal 108 is provided to Internet connecting apparatus 103, it is possible to store in Internet connecting apparatus 103 connected to moving picture playback apparatus 101, information such as in what state and how long a moving picture and audio information played back by moving picture playback apparatus 101 are played back.

According to one embodiment of the present invention, when website information is obtained by an Internet search using search keywords and search site URL information which are recorded in a medium, a storage medium such as memory 104 of Internet connecting apparatus 103 records the URL information, so that, even when moving picture playback apparatus 101 does not have a non-volatile storage medium and website information cannot be found, it is possible to store in Internet connecting apparatus 103 connected to moving picture playback apparatus 101 that URL information for website information including content similar to the website information that cannot be found is obtained instead.

According to one embodiment of the present invention, in a storage medium such as memory 102 provided to moving picture playback apparatus 101, by setting one or a plurality of URL information 106 to an arbitrary object, scene or button, a creator of a moving picture and audio information can provide URL information 106 intended by the creator to a viewer, and accordingly the viewer can easily obtain URL information 106.

According to one embodiment of the present invention, a storage medium such as memory 102 provided to moving picture playback apparatus 101 can collectively store one or a plurality of URL information 106 in one URL table 107 and is a storage medium such as a memory that stores URL table 107. Therefore, when URL information 106 is transmitted to Internet connecting apparatus 103 from moving picture playback apparatus 101, URL information 106 can be obtained from URL table 107 stored in the memory without searching URL information 106 from a recording medium placed into moving picture playback apparatus 101, so that it is possible to make the processing for obtaining URL information 106 easy.

According to one embodiment of the present invention, by providing to moving picture playback apparatus 101 at least one of the above-described LSI and a storage medium such as memory 102 that records the above-described program (software), it is possible to utilize the Internet by using an Internet function provided to Internet connecting apparatus 103 connected to moving picture playback apparatus 101.

According to one embodiment of the present invention, Internet connecting apparatus 103 can provide an Internet function to moving picture playback apparatus 101 by having an Internet function and connecting to moving picture playback apparatus 101 having at least one of the above-described LSI and program (software) and having memory 102 having all or part of the above-described functions.

According to one embodiment of the present invention, when an object having URL information 106 is displayed on a screen of Internet connecting apparatus 103, a mark is displayed on the screen to report to the viewer that the object has URL information 106. Thus, by displaying a mark while the viewer is viewing a moving picture and audio information so as not to hinder the playback of the moving picture, it is possible to allow the viewer to recognize that URL information 106 is recorded in the object being displayed without annoying the viewer.

According to one embodiment of the present invention, when an object or scene having URL information 106 is displayed on a screen of Internet connecting apparatus 103, the object is highlight displayed or the button associated with the object is displayed to report to the viewer that the object or scene has URL information 106. Therefore, it is possible to allow the viewer to recognize which object or scene has URL information 106. In addition, by combining with the above-described reporting method, even during the playback of a moving picture and audio information, the viewer can easily recognize the object having URL information 106 and select and specify an object or scene.

According to one embodiment of the present invention, when the viewer who recognizes that the object displayed on a screen of Internet connecting apparatus 103 has URL information 106 presses a remote control key or a main body key, a website based on URL information 106 is displayed on the screen of Internet connecting apparatus 103. Therefore, without the viewer directly typing URL information 106, whatever URL information 106 is, a website based on URL information 106 can be easily displayed by the same operation on the screen of Internet connecting apparatus 103.

According to one embodiment of the present invention, while moving picture playback apparatus 101 is performing processing of connecting to Internet network 114 through Internet connecting apparatus 103, by displaying a message such as “connecting” or an object or button having URL information with its color being changed on a screen of the Internet connecting apparatus or the moving picture playback apparatus, the viewer can easily recognize the states of moving picture playback apparatus 101 and Internet connecting apparatus 103.

According to one embodiment of the present invention, when, as a result of an attempt by moving picture playback apparatus 101 to connect to Internet network 114 through Internet connecting apparatus 103, the connection has failed or succeeded, by displaying a message such as “connection failed” or “connection succeeded” or displaying an object or button having URL information with its color being changed, on a screen of the Internet connecting apparatus or the moving picture playback apparatus, the viewer can easily recognize the states of moving picture playback apparatus 101 and Internet connecting apparatus 103.

According to one embodiment of the present invention, when Internet connecting apparatus 103 is in transition of connecting to the Internet or has succeeded in Internet connection or during viewing of the Internet or after viewing of the Internet, the playback state of a medium played back by moving picture playback apparatus 101 is maintained as it is for when the viewer starts to view the Internet or is switched to that different from the playback state for when the viewer starts to view the Internet. Therefore, when moving picture playback apparatus 101 switches among a moving picture, audio information and the Internet function, the state of the moving picture and audio information can be set according to a viewer's preference.

According to one embodiment of the present invention, when Internet connecting apparatus 103 is in transition of connecting to the Internet or has succeeded in Internet connection or during viewing of the Internet or after viewing of the Internet, the playback position of a medium played back by moving picture playback apparatus 101 is maintained as it is for when the viewer starts to view the Internet or is switched to that different from the playback position for when the viewer starts to view the Internet. Thus, when moving picture playback apparatus 101 switches among a moving picture, audio information and the Internet function, the playback position of the moving picture and audio information can be set according to a viewer's preference.

According to one embodiment of the present invention, when moving picture playback apparatus 101 receives Internet disconnection signal 802, obtained URL information is stored or rewritten in memory 102 provided to moving picture playback apparatus 101 or a medium. Accordingly, the viewer can always obtain and access URL information including content similar to URL information associated with the object displayed by a medium being played back by moving picture playback apparatus 101.

The present application is based on Japanese Patent Application No. 2005-35019, filed on Feb. 10, 2005 and Japanese Patent Application No. 2006-9214, filed on Jan. 17, 2006, the entire content of which is expressly incorporated by reference herein.

### INDUSTRIAL APPLICABILITY

According to a communication method, a moving picture playback apparatus and an Internet connecting apparatus of the present invention, by using an Internet function of the Internet connecting apparatus connected to the moving picture playback apparatus, it is possible to connect to the Internet, and thus the moving picture playback apparatus does not need to have an Internet function. Accordingly, the present invention is useful as a system.

1. A communication method for a moving picture playback apparatus capable of playing back multimedia data and not having a communication processing section for Internet connection, the communication method comprising:
connecting the moving picture playback apparatus to an Internet connecting apparatus having a communication processing section for Internet connection; and
transmitting an Internet connection signal which is a signal for establishing an Internet connection by the Internet connecting apparatus, to the Internet connecting apparatus from the moving picture playback apparatus, and thereby the moving picture playback apparatus connects to the Internet through the Internet connecting apparatus.

2. The communication method according to claim 1, further comprising:
transmitting, by the moving picture playback apparatus, an Internet search signal which is a signal for performing a search on an Internet network by the Internet connecting apparatus, to the Internet connecting apparatus when the Internet connecting apparatus fails in the Internet connection using the Internet connection signal transmitted from the moving picture playback apparatus; and
receiving, by the moving picture playback apparatus, search result information which is information of a result of the search performed by the Internet connecting apparatus using the Internet search signal, and thereby the moving picture playback apparatus connects to the Internet through the Internet connecting apparatus.

3. The communication method according to claim 1, further comprising displaying a mark on a screen of the Internet connecting apparatus to report that an object which is an element composing the multimedia data being played back by the moving picture playback apparatus, has URL information which is included in the Internet connection signal.

4. The communication method according to claim 1, further comprising highlight displaying an object displayed on a screen of the Internet connecting apparatus to report that the object which is an element composing the multimedia data being played back by the moving picture playback apparatus, has URL information which is included in the Internet connection signal.

5. The communication method according to claim 1, further comprising displaying a button on a screen of the Internet connecting apparatus to report that an object which is an element composing the multimedia data being played back by the moving picture playback apparatus, has URL information which is included in the Internet connection signal.

6. The communication method according to claim 5, further comprising reporting to a viewer that the object has the URL information by highlight displaying the object when a scene having the URL information is displayed.

7. The communication method according to claim 1, further comprising displaying on a screen of the Internet connecting apparatus a message reporting that the moving picture playback apparatus is in transition of connecting to the Internet.

8. The communication method according to claim 1, further comprising changing a color of an object or a button displayed on a screen of the Internet connecting apparatus to report that the moving picture playback apparatus is in transition of connecting to the Internet, the object having URL information and being an element composing the multimedia.

9. The communication method according to claim 1, further comprising displaying on a screen of the Internet connecting apparatus a message indicating that the moving picture playback apparatus has succeeded in the Internet connection.

10. The communication method according to claim 1, further comprising changing a color of an object or a button displayed on a screen of the Internet connecting apparatus to report that the moving picture playback apparatus has succeeded in the Internet connection, the object having URL information and being an element composing the multimedia data.

11. The communication method according to claim 1, further comprising displaying on a screen of the Internet connecting apparatus a message indicating that the moving picture playback apparatus has failed in the Internet connection.

12. The communication method according to claim 1, further comprising changing a color of an object or a button displayed on a screen of the Internet connecting apparatus to report that the moving picture playback apparatus has failed in the Internet connection, the object having URL information and being an element composing the multimedia data.

13. The communication method according to claim 1, further comprising providing to the Internet connecting apparatus from the moving picture playback apparatus a playback position of the multimedia data being played back by the moving picture playback apparatus, when a screen display of the Internet connecting apparatus connected to the moving picture playback apparatus is switched from a medium playback display provided by the moving picture playback apparatus to an Internet display provided by the Internet connecting apparatus.

14. The communication method according to claim 1, further comprising providing to the Internet connecting apparatus from the moving picture playback apparatus a playback state of the multimedia data being played back by the moving picture playback apparatus, when a screen display of the Internet connecting apparatus connected to the moving picture playback apparatus is switched from a medium playback display provided by the moving picture playback apparatus to an Internet display provided by the Internet connecting apparatus.

15. The communication method according to claim 1, further comprising providing to the Internet connecting apparatus from the moving picture playback apparatus URL information associated with an object displayed by the multimedia data being played back by the moving picture playback apparatus, when a screen display of the Internet connecting apparatus connected to the moving picture playback apparatus is switched from a medium playback display provided by the moving picture playback apparatus to an Internet display provided by the Internet connecting apparatus.

16. The communication method according to claim 2, wherein the Internet search signal includes search site URL information used to search for a search engine, when a website cannot be found as a result of a search for the website based on URL information included in the Internet connection signal, and a search keyword used to search for a website including content similar to the website by the search engine searched using the search site URL information.

17. The communication method according to claim 1, further comprising providing to the moving picture playback apparatus from the Internet connecting apparatus a playback position of the multimedia data being played back by the moving picture playback apparatus, when a screen display of the Internet connecting apparatus connected to the moving picture playback apparatus is switched from an Internet display provided by the Internet connecting apparatus to a medium playback display provided by the moving picture playback apparatus.

18. The communication method according to claim 1, further comprising providing to the moving picture playback apparatus from the Internet connecting apparatus a playback state of the multimedia data being played back by the moving picture playback apparatus, when a screen display of the Internet connecting apparatus connected to the moving picture playback apparatus is switched from an Internet display provided by the Internet connecting apparatus to a medium playback display provided by the moving picture playback apparatus.

19. The communication method according to claim 2, wherein, when a website cannot be found as a result of a search for the website based on URL information included in the Internet connection signal, the search result information includes URL information for a website including content similar to the website.

20. A moving picture playback apparatus capable of playing back multimedia data and not having a communication processing section for Internet connection, the moving picture playback apparatus comprising:
a generating section that generates an Internet connection signal which is a signal for establishing an Internet connection by an Internet connecting apparatus having an Internet connection function;
a transmitting section that transmits the Internet connection signal generated by the generating section; and
a receiving section that receives URL information as a result of the Internet connection through the Internet connecting apparatus based on the Internet connection signal transmitted by the transmitting section.

21. The moving picture playback apparatus according to claim 20, wherein the generating section generates the Internet connection signal including Internet connection request information and URL information which are transmitted to an Internet network from the Internet connecting apparatus, and medium playback position information and medium playback state information which are stored in the storage medium of the Internet connecting apparatus, the medium playback position information being information of a playback position of the multimedia data being played back, and the medium playback state information being information of a playback state of the multimedia data being played back.

22. The moving picture playback apparatus according to claim 20, wherein:
the generating section generates an Internet search signal which is a signal for performing an Internet search, when the Internet connection using the Internet connection signal transmitted by the transmitting section fails;
the transmitting section transmits the Internet search signal generated by the generating section; and
the receiving section receives URL information as a result of the Internet connection through the Internet connecting apparatus based on the Internet search signal transmitted by the transmitting section.

23. The moving picture playback apparatus according to claim 22, wherein the generating section generates the Internet search signal including search site URL information used to search for a search engine and a search keyword used to search for a website including content similar to the website by the search engine searched using the search site URL information, when a website cannot be found as a result of a search for the website based on URL information recorded in a medium being played back by the moving picture playback apparatus.

24. The moving picture playback apparatus according to claim 20, further comprising a storing section that stores the URL information received by the receiving section.

25. An Internet connecting apparatus capable of playing back multimedia data, connected to a moving picture playback apparatus not having a communication processing section for Internet connection, and transmitting and receiving an Internet connection signal and an Internet disconnection signal, the Internet connecting apparatus comprising:
a receiving section that receives the Internet connection signal transmitted from the moving picture playback apparatus upon Internet connection and receives the Internet disconnection signal transmitted from a server upon Internet disconnection;
a storing section that stores medium playback position information and medium playback state information which are included in the Internet connection signal received by the receiving section, the medium playback position information being information of a playback position of the multimedia data being played back, and the medium playback state information being information of a playback state of the multimedia data being played back;
a generating section that generates Internet connection request information which is information for requesting the server for Internet connection when the receiving section receives the Internet connection signal; and
a transmitting section that transmits, upon Internet connection, the Internet connection request information generated by the generating section and transmits, upon Internet disconnection, to the moving picture playback apparatus the medium playback position information and the medium playback state information which are stored in the storing section.

26. The Internet connecting apparatus according to claim 25, further comprising a changing section that changes the medium playback position information and the medium playback state information which are stored in the storing section,
wherein the transmitting section transmits, upon Internet disconnection, the medium playback position information and the medium playback state information which are changed by the changing section.
